(19) United States
(12) Patent Application Publication
(10) Pub. No.: US 2010/0083820 A1
(43) Pub. Date: Apr. 8, 2010

(54) BALLISTIC SHIELD WITH LIGHTING

(76) Inventors: Edward R. Doyner, Spindale, NC (US); Michael Ott, Spindale, NC (US)

Correspondence Address: GREENBERG TRAURIG, LLP, MET LIFE BUILDING, 200 PARK AVENUE, NEW YORK, NY, 10166, US

(21) Appl. No.: 12/575,154

(22) Filed: Oct. 7, 2009

Related U.S. Application Data
(60) Provisional application No. 61/103,723, filed on Oct. 8, 2008.

(51) Int. Cl. F41H 5/08; F21L 4/00; F21L 4/02; F41H 5/26; F41H 5/02

(52) U.S. Cl. 89/36.02; 362/190; 362/184; 89/36.07

(57) ABSTRACT

Various embodiments of the present invention relate to protective shields, and more particularly, to ballistic shields. For the purposes of describing and claiming the present invention the term “ballistic shield” is intended to refer to a shield designed to minimize the chances of a fatality or serious injury in the event of a bullet strike, shrapnel strike, or the like (but not necessarily to be impenetrable to all types of strikes under all conditions).

### RELATED APPLICATIONS

This application claims the benefit of U.S. Provisional Application Ser. No. 61/103,723, filed Oct. 8, 2008. The aforementioned application is incorporated herein by reference in its entirety.

### FIELD OF THE INVENTION

Various embodiments of the present invention relate to protective shields, and more particularly, to ballistic shields.

For the purposes of describing and claiming the present invention the term “ballistic shield” is intended to refer to a shield designed to minimize the chances of a fatality or serious injury in the event of a bullet strike, shrapnel strike, or the like (but not necessarily to be impenetrable to all types of strikes under all conditions).

Further, for the purposes of describing and claiming the present invention when a direction is indicated as “away” (e.g., away from a surface or away from a user), what is meant is not necessarily perpendicular, but simply in a direction of increasing distance.

### BACKGROUND OF THE INVENTION

Protective shields are often utilized by law enforcement and military personnel to provide protection against ballistic threats such as firearms.

Examples of patents relating to shields include the following:

U.S. Pat. No. 6,389,949, entitled SHIELDING DEVICE, issued May 21, 2002 in the name of Carreira.

U.S. Pat. No. 6,595,101, entitled BALLISTIC SHIELD AND METHODS OF USE AND FORMATION, issued Jul. 22, 2003 in the name of Baker.

U.S. Pat. No. 6,990,887, entitled PROTECTIVE SHIELD, issued Jan. 31, 2006 in the name of O'Donnell.

U.S. Pat. No. 7,124,675, entitled PORTABLE BALLISTIC SHIELD AND SHOOTING PLATFORM FOR POLICE AND MILITARY PERSONNEL, issued Oct. 24, 2006 in the name of Sand.

U.S. Pat. No. 7,243,590, entitled PROTECTIVE BALLISTIC WEAPONS STANDS AND TRANSPARENT SHIELDS USABLE THEREWITH, issued Jul. 17, 2007 in the name of McClellan et al.

U.S. Pat. No. 7,302,880, entitled BALLISTIC SHIELD WITH INTEGRAL FIREARM, issued Dec. 4, 2007 in the name of Elasic.

U.S. Pat. No. 7,424,844, entitled PORTABLE BALLISTIC SHIELD, issued Sep. 16, 2008 in the name of Carter.

### BRIEF DESCRIPTION OF THE DRAWINGS

FIG. 1 illustrates a front view of a protective shield in accordance with an embodiment of the present invention.

FIG. 2 illustrates an inside view of the protective shield of FIG. 1.

FIG. 3 illustrates a side cross-sectional view (looking into the shield from one side) of a protective shield of the type of FIG. 1.

FIG. 4 illustrates a top cross-sectional view (looking down into the shield) of a protective shield of the type of FIG. 1.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

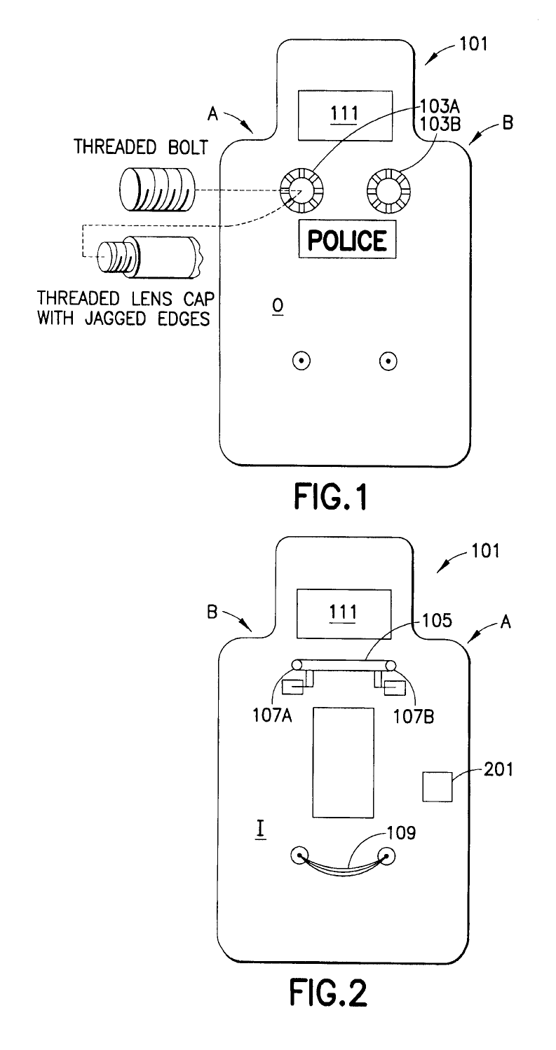

Referring now to FIGS. 1 and 2, it is seen that the shield 101 may incorporate one or more light sources 103A,103B, a power source (in this example, the batteries inside of the handle 105), and at least one control mechanism (in this example, each end of the handle 105 may have a switch 107A,107B (e.g., a pressure thumb pad switch) to control the light source(s)). In one example, an additional handle or strap 109 may be provided as well as a view port 111. Of course, any desired number of light source(s), power source(s), control mechanism(s), handle(s)/strap(s) and/or view port(s) may be utilized.

As seen, in this example the handle 105 may be a tube-like sealed (or, in another example, re-sealable) container. In one specific example, the handle 105 may house four 3 volt lithium batteries (in one example, the batteries may be replaceable). In another specific example, the handle 105 may be 6½ inches long. In another specific example, the handle 105 may be capable of being retrofitted to the M.U.S.T. Shield from FIRST CHOICE ARMOR. In another specific example, the handle 105 may have a diameter of a minimum of 1″. In another specific example, there may be a minimum of 1″ overlap on both ends of the handle 105. In another specific example, the handle may have a circular cross-section (or any other desired shape).

In another example, one or more threaded bolts (and/or one or more flashlight heads/lenses/caps) may be utilized (in one specific example, the threaded bolt may be a 1″ threaded bolt).

In another example, a 1″-2″ flashlight head/lens/cap may accommodate the 1″ threaded bolt system (e.g., the threaded bolt may extend through an aperture in the flashlight head/lens/cap).

In another example, the lighting mechanism may be essentially electrically conductive to accommodate the tube-like handle system. In one specific example, the tube-like handle system may have a thumb pressure pad switch on one or both sides.

In another example, the flashlight head/lens/cap may be water resistant.

In another example, the flashlight head/lens/cap may extend a minimum of 1″ from the view port cover. In one specific example, the flashlight head/lens/cap may have jagged edges (e.g., at a front or free end).

In another example, the light intensity may be a minimum of 80 Lumens.

In another example, each of the light source(s) may be a Xenon and/or LED type light source.

In another example, each of the light source(s) may have strobe capacity. In one specific example, the strobe frequency may be selected to cause (or tend to cause) blindness (either full or partial and either temporary or permanent).

In one example, the light power (e.g., measured in Lumens) may be selected to cause (or tend to cause) blindness (either full or partial and either temporary or permanent).

In another example, the position of the light source(s) and/or flashlight head(s)/lens(es)/cap(s) may be essentially center of mass (thus providing greater protection for the operator).

In another example, the light source(s) may be interchangeable.

In another example, the flashlight head(s)/lens(es)/cap(s) may be interchangeable.

In another example, the threaded bolt(s) may be interchangeable.

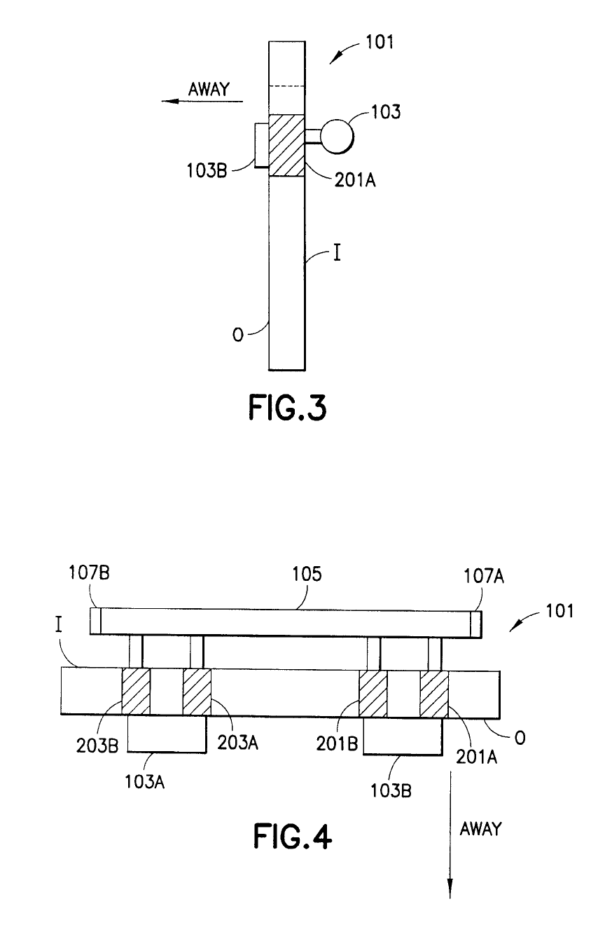

In another example, there may be no through hole through the shield for the light source(s). For example, the light source(s) may be mounted to the front of the shield, the handle (including power source and one or more switches) may be mounted to the rear of the shield, and the light source(s) may be powered and controlled through conductive elements formed as part of the shield (either integrally formed or added, such as via one or more inserts (e.g., one or more threaded bolts, one or more rods, or the like)). See, for example, FIGS. 3 and 4, showing conductive elements 201A,201B, 203A,203B, which may form circuits to conduct electricity from the batteries in handle 105 to the light sources 103A,103B. Of course, these FIGS. are provided as an example only, and any desired circuit configuration may be utilized.

As shown and described herein, various embodiments of the present invention may provide for one or more of:
A lightweight shield. In one example, the light system may add only about 1 pound. In another example, the light system may be utilized in conjunction with the M.U.S.T. Shield from FIRST CHOICE ARMOR so that total shield weight is about 15 pounds.
A user-friendly handle (e.g., for right and/or left hand hold).
A configuration minimizing the chances of the user losing grip while activating the light source(s).
A user-friendly configuration with regard to the use of weapons (e.g., handgun, rifle, submachine gun):
   In various examples, such weapons may be used from the following positions:
      Standing
      Kneeling
      Prone
   In various examples, such weapons may be manipulated from simple magazine exchanges to class three malfunctions with two hands.
Use of common batteries that are easy to replace (e.g., 3 volt lithium batteries).
Use of flashlight head(s)/lens(es)/cap(s) with jagged edges that can be utilized, for example, as follows:
   As an offensive weapon
   To protect the view port (e.g., essentially transparent view port) from scratches (the view port may be provided to give the user increased visibility)

As shown and described herein, various embodiments of the present invention may provide a M.U.S.T. Shield from FIRST CHOICE ARMOR having a lighting system. In this regard, such a M.U.S.T. Shield from FIRST CHOICE ARMOR having a lighting system may be deployed (for example) into numerous patrol and/or tactical applications and may provide one or more of the following:
Light weight
Mobility
Simple pressure pad switch for right or left hand hold
Blinding Lumens
Disorientation of people by using strobe light(s)
Directional lighting for deployment

In another example, the threaded bolt(s) may be used as an offensive weapon.

In another example, one or more spikes or the like (e.g., threaded spikes) may be used in place of (or in addition to) the threaded bolt(s) as an offensive weapon.

In another example, various embodiments of the present invention may be applied to the M.U.S.T. Shield from FIRST CHOICE ARMOR.

In another example, the shield may comprise: polycarbonate, lexan, plastic, Kevlar, boron carbide, silicon carbide, silicon nitride, aluminum oxide, alumina ceramic, titanium diboride, reinforced fiberglass composite, reinforced fiber and polymer resin composite, and/or combinations and/or mixtures of such materials.

In another example, the shield may be made of a strong material (e.g., Level IIIA ballistic material), so as to provide frontal protection to the user.

In another example, one or more Level IV ballistic inserts may be attached (e.g., releasably attached) to the shield.

In another example, the shield may be configured to stand unattended (e.g., be deployed on the ground as a fixed barrier to mitigate direct fire and/or ricochets)

In another example, the shield may be adapted for use by military, law enforcement, school, fire, and/or rescue personnel. Specific uses for the shield may include (but not be limited to): active shooter response, dynamic entries, covert searches, officer and victim rescues, hazardous suspect and vehicle approaches, and crowd control.

In other examples, any desired combination of one or more threaded bolts, one or more threaded spikes, one or more flashlight heads/lenses/caps, etc. may be used (e.g., in connection with one or more light sources).

In another embodiment of the present invention, a shield (see, e.g., shield 101 of FIGS. 1-4), wherein the shield has at least one light source (see, e.g., light sources 103A,103B of FIGS. 1-4) powered by at least one battery is provided, comprising: a shield body, the shield body having an inside surface (see, e.g., inside surface “I” of FIGS. 2-4) generally facing a user of the shield when the shield is held by the user and an outside surface (see, e.g., outside surface “O” of FIGS. 1, and 3-4) generally facing away from the user of the shield when the shield is held by the user; and at least one handle (see, e.g., handle 105 of FIGS. 2-4); wherein the at least one light source is disposed to project light from the outside surface in a direction generally away from the inside surface (see, e.g., arrow “Away” of FIGS. 3-4); wherein the handle comprises an elongated structure having a first end and a second end; wherein the handle is configured to receive therein the at least one battery for powering the at least one light source; wherein a first control mechanism is disposed at the first end of the elongated structure (see, e.g., switch 107A of FIGS. 2 and 4); wherein a second control mechanism is disposed at the second end of the elongated structure (see, e.g., switch 107B of FIGS. 2 and 4); and wherein the light source is operatively connected to the at least one battery, the first control mechanism and the second control mechanism such that the light source may be powered by the at least one battery and controlled by each of the first control mechanism and the second control mechanism. In one example, the light source may be operatively connected to the battery, the first control mechanism and the second control mechanism through one or more conductive paths. In another example, each of the first control mechanism and the second control mechanism may control the same light in an independent manner. In another example, having the first control mechanism and the second control mechanism may provide for easy use by a right-handed or left-handed user (e.g., one control mechanism may be positioned to be operable by a right hand of a user (e.g., the user's thumb) and the other control mechanism may be positioned to be operable by a left hand of a user (e.g., the user's thumb)).

In another example, the light source may extend out from the outside surface (see, e.g., outside surface “O” of FIGS. 1 and 3-4) in a direction generally away (see, e.g., arrow “Away”) from the inside surface “I” (see, e.g., inside surface “I” of FIGS. 2-4).

In another example, a free end of the light source may comprise at least one jagged edge.

In another example, the free end of the light source may comprise a plurality of jagged edges.

In another example, the shield may comprise a plurality of light sources.

In another example, each of the plurality of light sources may extend out from the outside surface in a direction generally away from the inside surface.

In another example, a free end of each of the light sources may comprise at least one jagged edge.

In another example, the free end of each of the light sources may comprise a plurality of jagged edges.

In another example, the first control mechanism may comprise a first switch and the second control mechanism may comprise a second switch.

In another example, the handle may be configured to receive therein a plurality of batteries for powering the at least one light source.

In another example, the at least one light source may be configured to provide strobe lighting.

In another example, the shield may further comprise a fastening element (see, e.g., fastening element 201 of FIG. 2) provided on the inside surface (see, e.g., inside surface “I” of FIGS. 2-4) to permit attachment of at least one accessory.

In another example, the fastening element may be a hook and loop fastening combination.

In another example, a plurality of fastening elements may be used.

In another example, the fastening element(s) may be placed anywhere desired on the shield (e.g., at a center of mass to provide extra protection to the user).

In another example, the at least one accessory may be selected from the group consisting of (but not limited to): a gun holster, a utility bag, a forearm pad, a laser, a taser, a light illuminator, a trauma kit, a magazine pouch, a night vision device, and a ballistic plate insert.

In another example, the shield may comprise Level IIIA ballistic material.

In another example, the shield may further comprise a viewport (see, e.g., viewport 111) to provide the user with visibility therethrough. In one example, the viewport may comprise a substantially transparent material. In another example, the viewport may comprise a material resistant to bullets and the like.

Of course, any embodiment/example described herein (or any feature or features of any embodiment/example described herein) may be combined with any other embodiment/example described herein (or any feature or features of any such other embodiment/example described herein).

While a number of embodiments of the present invention have been described, it is understood that these embodiments are illustrative only, and not restrictive, and that many modifications may become apparent to those of ordinary skill in the art. For example, while the shield of the present invention has been described principally as bullet or shrapnel resistant, the shield may also (or instead) be designed to be resistant to sharp and/or blunt weapons (e.g., knives, clubs, etc.). Further, a shield according to the present invention may be designed such that certain components are reusable. Further still, shields of the present invention may comprise any desired materials (e.g., aramid fiber; nylon; rayon; cotton, and/or ceramic). Further still, lower “shelf” areas at the upper right and left of the shield (see, e.g., “A” and “B” of FIGS. 1 and 2) may be configured to support the barrel of a handgun, rifle or other weapon (in this regard, a “shelf” may have one or more indentations or other features to hold and/or steady a barrel of a weapon). Further still, any desired number of light source(s), switch(es), flashlight head(s)/lens(es)/cap(s), threaded bolt(s), threaded spike(s), or the like may be used. Further still, any steps may be performed in any desired order (and any desired steps may be added and/or any desired steps may be deleted).

What is claimed is:

1. A shield, wherein the shield has at least one light source powered by at least one battery, comprising:
a shield body, the shield body having an inside surface generally facing a user of the shield when the shield is held by the user and an outside surface generally facing away from the user of the shield when the shield is held by the user; and
at least one handle;
wherein the at least one light source is disposed to project light from the outside surface in a direction generally away from the inside surface;
wherein the handle comprises an elongated structure having a first end and a second end;
wherein the handle is configured to receive therein the at least one battery for powering the at least one light source;
wherein a first control mechanism is disposed at the first end of the elongated structure;
wherein a second control mechanism is disposed at the second end of the elongated structure; and
wherein the light source is operatively connected to the at least one battery, the first control mechanism and the second control mechanism such that the light source may be powered by the at least one battery and controlled by each of the first control mechanism and the second control mechanism.

2. The shield of claim 1, wherein the light source extends out from the outside surface in a direction generally away from the inside surface.

3. The shield of claim 2, wherein a free end of the light source comprises at least one jagged edge.

4. The shield of claim 3, wherein the free end of the light source comprises a plurality of jagged edges.

5. The shield of claim 1, comprising a plurality of light sources.

6. The shield of claim 5, wherein each of the plurality of light sources extends out from the outside surface in a direction generally away from the inside surface.

7. The shield of claim 6, wherein a free end of each of the light sources comprises at least one jagged edge.

8. The shield of claim 7, wherein the free end of each of the light sources comprises a plurality of jagged edges.

9. The shield of claim 1, wherein the first control mechanism comprises a first switch and the second control mechanism comprises a second switch.

10. The shield of claim 1, wherein the handle is configured to receive therein a plurality of batteries for powering the at least one light source.

11. The shield of claim 1, wherein the at least one light source is configured to provide strobe lighting.

12. The shield of claim 1, further comprising a fastening element provided on the inside surface to permit attachment of at least one accessory.

13. The shield of claim 12, wherein the fastening element is a hook and loop fastening combination.

14. The shield of claim 13, wherein the at least one accessory is selected from the group consisting of: a gun holster, a utility bag, a forearm pad, a laser, a taser, a light illuminator, a trauma kit, a magazine pouch, a night vision device, and a ballistic plate insert.

15. The shield of claim 1, wherein the shield comprises Level IIIA ballistic material.

16. The shield of claim 1, further comprising a viewport to provide the user with visibility therethrough.
